(19) United States
(12) Patent Application Publication
(10) Pub. No.: US 2014/0019452 A1
(43) Pub. Date: Jan. 16, 2014

(54) METHOD AND APPARATUS FOR CLUSTERING SEARCH TERMS

(71) Applicants: Nan He, Shenzhen City (CN); Di Wang, Shenzhen City (CN); Yang Guo, Shenzhen City (CN); Lixin Hu, Shenzhen City (CN); Yanmin Wang, Shenzhen City (CN); Jianpeng Zhu, Shenzhen City (CN)

(72) Inventors: Nan He, Shenzhen City (CN); Di Wang, Shenzhen City (CN); Yang Guo, Shenzhen City (CN); Lixin Hu, Shenzhen City (CN); Yanmin Wang, Shenzhen City (CN); Jianpeng Zhu, Shenzhen City (CN)

(73) Assignee: TENCENT TECHNOLOGY (SHENZHEN) COMPANY LIMITED, Shenzhen City, Guangdong (CN)

(21) Appl. No.: 14/000,083

(22) PCT Filed: Feb. 1, 2012
(86) PCT No.: PCT/CN2012/070824

§ 371 Date: Sep. 4, 2013

(30) Foreign Application Priority Data
Feb. 18, 2011 (CN) 201110043030.7

(51) Int. Cl. G06F 17/30

(52) U.S. Cl. CPC G06F 17/30705
USPC 707/737

(57) ABSTRACT

A method and apparatus for clustering search terms are provided by the present invention. The method includes: A, establishing a candidate search term set, wherein the candidate search term set comprises a first search term provided by a user, and a second search term related to the first search term; B, performing a clustering operation on the first search term and the second search term related to the first search term in the candidate search term set according to text characteristic and/or semantic characteristic of search term. The accuracy and relevance of search term clustering can be improved by use of the method.

The present application claims the benefit and priority of Chinese Patent Application No. 201110043030.7, filed on Feb. 18, 2011 and named “method and apparatus for clustering search terms”. The entire disclosures of the previous Chinese application are incorporated herein by reference.

### FIELD OF THE INVENTION

The present invention relates to network search technology, and particularly to a method and apparatus for clustering search terms.

### BACKGROUND OF THE INVENTION

In network search technology, a user usually searches out a result through a corresponding search term. In a bid advertising system, the search term may be an identifier of an advertisement provided by an advertiser, and be referred to as a purchase word. The purpose is to facilitate the user to search out the corresponding advertisement through the search term.

In the bid advertising system, in order to improve the advertisement display quality, it is necessary to cluster search terms provided by the advertiser. A process for clustering the search terms can be abstracted as a process for performing clustering to a set of short text strings.

Currently, the most commonly-used method for clustering includes operations as follows: for a search term provided by an advertiser, search terms which are the most literally similar to the provided search term are searched out from existing search terms provided by all advertisers, and the search term provided by the advertiser is clustered together with the searched out search terms. As such, when a user of a search engine retrieves a corresponding advertisement through a search term, the advertisement corresponding to the search term are displayed to the user together with advertisements corresponding to search terms clustered with the search term.

However, there are some search terms that substantially relate to the advertisement corresponding to the search term provided by the advertiser although the search terms are not provided by the advertisers. The aforesaid method for clustering is just to literally cluster the search terms provided by the advertiser without considering other search terms which semantically relate to the search term provided by the advertiser and have not currently been provided by the advertiser, thereby reducing the accuracy of clustering search terms.

### SUMMARY OF THE INVENTION

A method and apparatus for clustering search terms are provided by the present invention, so as to improve the accuracy and relevance of clustering the search terms.

A technical solution provided by the present invention includes:

A method for clustering search terms includes:

establishing a candidate search term set, wherein the candidate search term set includes a first search term provided by a user, and a second search term related to the first search term; and

performing a clustering operation on the first search term and the second search term related to the first search term in the candidate search term set according to text characteristic and/or semantic characteristic of search term.

An apparatus for clustering search terms includes:

an establishing unit, to establish a candidate search term set, wherein the candidate search term set includes a first search term provided by a user, and a second search term related to the first search term; and

a clustering unit, to perform a clustering operation on the first search term and the second search term related to the first search term in the candidate search term set according to text characteristic and/or semantic characteristic of search term.

As can be seen from the above technical solution, in the method and apparatus provided by embodiments of the present invention, when search terms are clustered, a search term provided by a user and other search terms related to the search term provided by the user are taken into account rather than only performing the clustering for the search term provided by the user just according to a literal relationship in prior art, and the clustering is performed for the search term provided by the user and other search terms related to the search term provided by the user according to text characteristic and/or semantic characteristic of search term, which obviously increases the accuracy and relevance of search term clustering.

### BRIEF DESCRIPTION OF DRAWINGS

FIG. 1 is a flowchart illustrating a basic process in accordance with an embodiment of the present invention;

FIG. 2a is a flowchart illustrating a process of step 102 in accordance with an embodiment of the present invention;

FIG. 2b is a flowchart illustrating a process for exploiting a potential clustering relationship in accordance with an embodiment of the present invention;

FIG. 3a is a schematic diagram illustrating a first structure of a topological graph among search terms in accordance with an embodiment of the present invention;

FIG. 3b is a schematic diagram illustrating a second structure of a topological graph among search terms in accordance with an embodiment of the present invention;

FIG. 3c is a schematic diagram illustrating a potential clustering relationship among search terms in accordance with an embodiment of the present invention;

FIG. 3d is a schematic diagram illustrating a third structure of a topological graph when a search term is added in accordance with an embodiment of the present invention;

FIG. 4 is a flowchart illustrating a process for newly adding a search term in accordance with an embodiment of the present invention;

FIG. 5 is a schematic diagram illustrating a basic structure of an apparatus in accordance with an embodiment of the present invention;

FIG. 6 is a schematic diagram illustrating a detailed structure of an apparatus in accordance with an embodiment of the present invention.

### DETAILED DESCRIPTION OF THE INVENTION

Hereinafter, the present invention will be described in further detail with reference to the accompanying drawings and examples to make the objective, technical solution and merits therein clearer.

In the present invention, when search terms are clustered, a search term provided by a user like an advertiser is clustered together with search terms related to the search term according to the text characteristic and/or the semantic characteristic of search term rather than is clustered just according to a literal relationship as in conventional technologies, so that the accuracy of clustering search terms is improved. A method provided by an embodiment of the present invention is described hereinafter.

FIG. 1 is a flowchart illustrating a basic process in accordance with an embodiment of the present invention. As shown in FIG. 1, the process includes steps as follows.

In step 101, a candidate search term set is established. The candidate search term set includes a first search term provided by a user, and a second search term related to the first search term.

In step 101, the second search term related to the first search term may be specifically determined according to any one of two ways shown as follows. In a first way, a search term matching the first search term provided by the user is determined, and the determined search term is determined as the second search term related to the first search term; in a second way, the first search term provided by the user is taken as a keyword word for search, and a search term in the search result is determined as the second search term related to the first search term provided by the user.

The search term obtained through the first way may be a search term obtained through performing a simple string conversion for the first search term provided by the user, or may be a search term that usually used together with the first search term, which is determined based on actual experiences. For example, if the first search term provided by the user is a coffee pot, based on experiences, it may know that the coffee pot is usually used together with a coffee mug and so on. Based on this, it may be determined that the search term matching the coffee pot provided by the user may be the coffee mug and so on.

Specifically, the search term obtained through the second way may be a search term in a search result when the first search term provided by the user is taken as a keyword for search. The search may be implemented through a user Query Bidterm Merge (QBM). In a specific implementation, the QBM may be as follows: taking the first search term provided by the user as an input for search; obtaining the search term from the search result; determining the obtained search term as the search term related to the first search term provided by the user.

So far, the candidate search term set may be obtained through step 101. It should be noted that in the embodiment of the present invention, it is necessary to ensure that there are not any repeated search terms in the candidate search term set obtained in step 101.

In step 102, a clustering operation is performed for the first search term and the second search term related to the first search term in the candidate search term set according to text characteristic and/or semantic characteristic of search term.

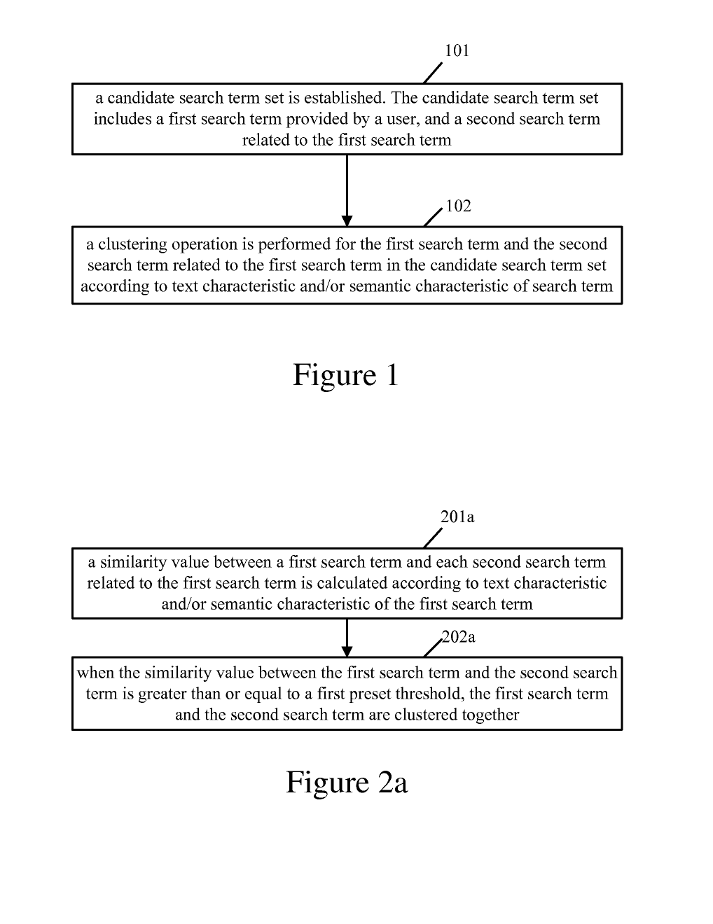

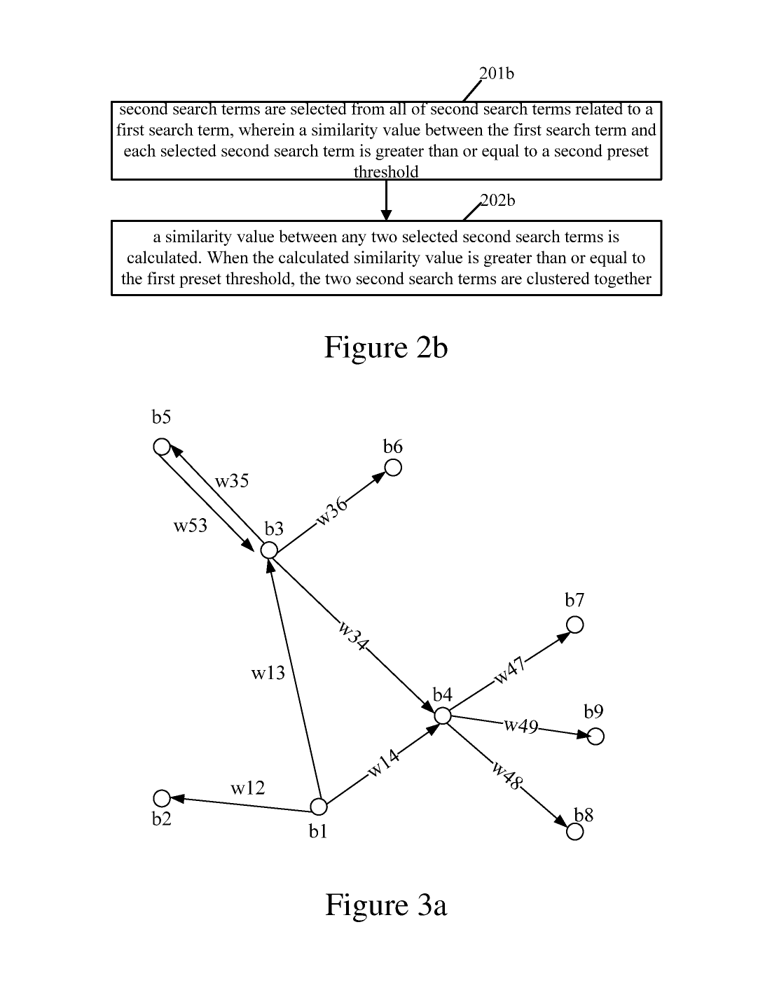

When step 102 is implemented, a similarity value between the first search term and the second search term related to the first search term in the candidate search term set may be calculated according to the text characteristic and/or the semantic characteristic of the first search term. The first search term is clustered together with the second search term which has a high similarity value with the first search term. Specifically, step 102 may be illustrated through a flowchart shown in FIG. 2a.

As shown in FIG. 2a, FIG. 2a is a flowchart illustrating a process of step 102 in accordance with an embodiment of the present invention. The process shows a principle for implementing a basic clustering relationship specifically. As shown in FIG. 2a, the process may include steps as follows.

In step 201a, a similarity value between a first search term and each second search term related to the first search term is calculated according to text characteristic and/or semantic characteristic of the first search term.

In step 202a, when the similarity value between the first search term and the second search term is greater than or equal to a first preset threshold, the first search term and the second search term are clustered together.

Through step 202a, the first search term and the second search term may be clustered together, wherein the second search term is related to the first search term and the similarity value between the first search term and the second search term is greater than or equal to the first preset threshold. Therefore, the basic clustering in the present invention can be implemented.

Preferably, in order to ensure a more complete clustering relationship, an embodiment of the present invention also provides a process for exploiting a potential clustering relationship, which may be illustrated through a process shown in FIG. 2b specifically.

As shown in FIG. 2b, FIG. 2b is a flowchart illustrating a process for exploiting a potential clustering relationship in accordance with an embodiment of the present invention. As shown in FIG. 2b, the process may include steps as follows.

In step 201b, second search terms are selected from all of second search terms related to a first search term, wherein a similarity value between the first search term and each selected second search term is greater than or equal to a second preset threshold.

As an extension of the embodiment of the present invention, in order to reduce the complexity for exploiting the potential clustering relationship, step 201b may alternatively be replaced as: selecting the second search terms from all of the second search terms clustered together with the first search term, wherein the similarity value with the first search term and each second search term is greater than or equal to the second preset threshold.

The second preset threshold in step 201b is unrelated with the first preset threshold in step 202a, these two thresholds may be equal, or may be not equal.

In step 202b, a similarity value between any two selected second search terms is calculated. When the calculated similarity value is greater than or equal to the first preset threshold, the two second search terms are clustered together.

The exploitation of the potential clustering relationship can be implemented through steps 201b to 202b.

Thus, in the embodiment of the present invention, a total clustering result may be formed through combining the first search term and the second search term clustered together in step 202a (i.e., the clustering relationship exists between the first search term and the second search term), as well as the second search term clustered together in step 202b. In the embodiment of the present invention, the clustering in step 202a and the clustering in step 202b may be implemented in accordance with an existing machine learning model, and are not specifically limited herein.

To make the process shown in FIG. 2 clearer, the process provided by the present invention is described hereinafter through an embodiment of the present invention.

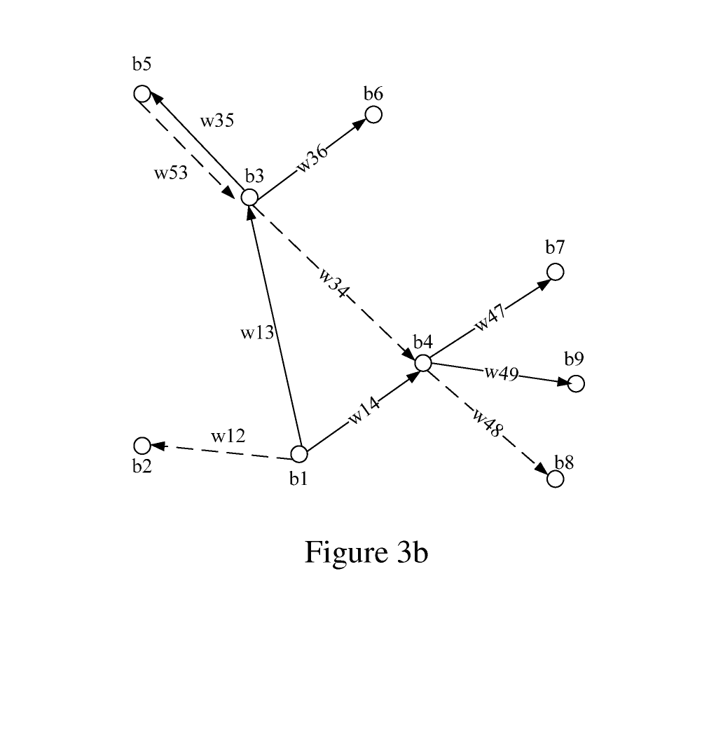

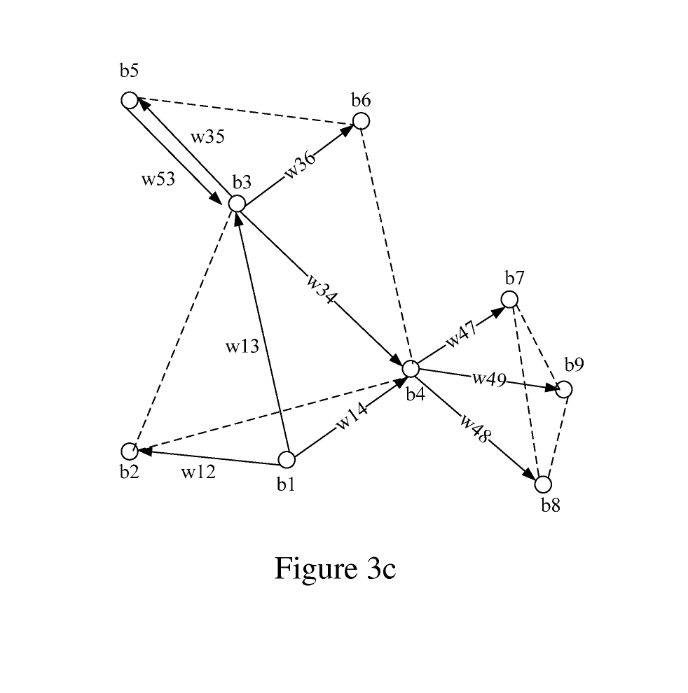

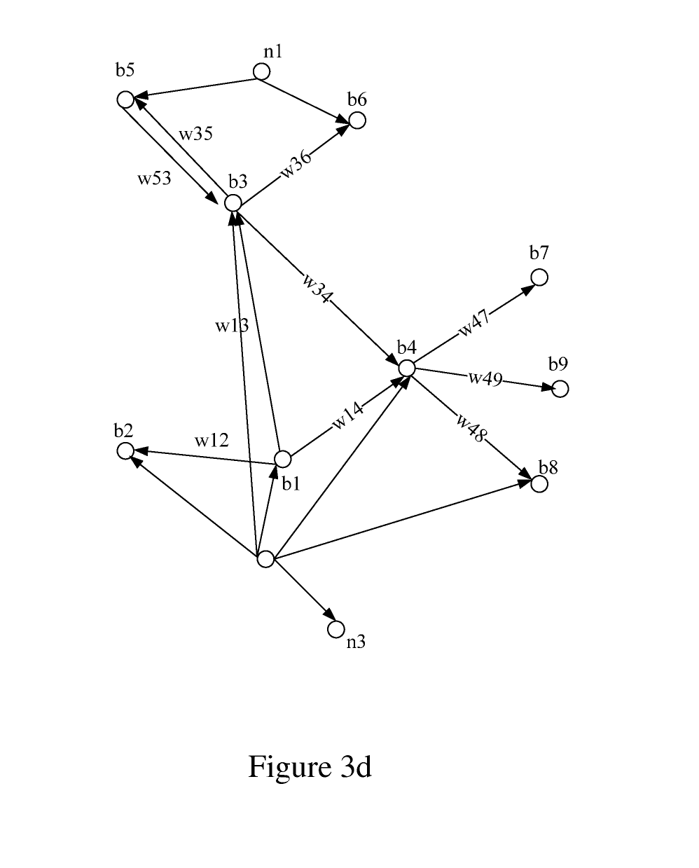

It is assumed that first search terms provided by a user are b1, b3, b4 and b5, respectively. Second search terms related to b1 are b2, b3 and b4It may be obtained through step 101. Second search terms related to b3 are b5, b6 and b4. Second search terms related to b4 are b7, b8 and b9. A second search term related to b5 is b3. All of the search terms are illustrated by a graph data structure shown in FIG. 3a. As shown in FIG. 3a, FIG. 3a is a schematic diagram illustrating a first structure of a topological graph among search terms in accordance with an embodiment of the present invention. In FIG. 3a, each search term is taken as node bi (a value of i is any of 1-9), an arrow from node bi to node bj (a value of j is any of 1-9) denotes that bj may be extended from bi, i.e., the search term related to bi is bj. As can be seen from FIG. 3a, the topological graph shown in FIG. 3a is a directed acyclic graph, i.e., a correlation between two search terms is not guaranteed to be bidirectional related, in particular, bj related to bi may be extended from bi. But it is not necessary that bi related to bj is extended from bj.

Thereafter, based on step 201a, it can be obtained that: for b1, according to the text characteristic and/or the semantic characteristic of b1, a similarity value w12 between b1 and b2, a similarity value w13 between b1 and b3, and a similarity value w14 between b1 and b4 are calculated. For b3, according to the text characteristic and/or the semantic characteristic of b3, a similarity value w14 between b3 and b4, a similarity value w35 between b3 and b5, and a similarity value w36 between b3 and b6 are calculated. For b4, according to the text characteristic and/or the semantic characteristic of b4, a similarity value w47 between b4 and b7, a similarity value w48 between b4 and b8, and a similarity value w49 between b4 and b9 are calculated. For b5, a similarity value w53 between b5 and b3 are calculated according to the text characteristic and/or the semantic characteristic of b5.

Afterwards, step 202a is performed for each first search term provided by the user in FIG. 3a. After step 202a is implemented, FIG. 3a may be changed to FIG. 3b. As shown in FIG. 3b, FIG. 3b is a schematic diagram illustrating a second structure of a topological graph among search terms in accordance with an embodiment of the present invention. FIG. 3b illustrates clustering relationships among interconnected search terms. In FIG. 3b, when two search terms are connected through a solid line, a clustering relation between the two search terms is that the two search terms are considered to be equivalent and may be clustered together. When two search terms are connected through a dashed line, a clustering relation between the two search terms is that the two search terms are not equivalent and may not be clustered together. The dashed line may be removed subsequently.

In the topological graph shown in FIG. 3a, potential clustering relationships may exist among second search terms related to a same first search term. Such clustering relationship may have already been found in step 203 (e.g., a clustering relationship between b3 and b4), or may not be found (e.g., a clustering relationship between b2 and b3). In order to make search term clustering more precise, according to the process for exploiting the potential clustering relationship shown in FIG. 2b, the potential clustering relationship may be obtained, and indicated by a dotted line in FIG. 3c. The first search term b1 provided by the user in FIG. 3c is taken as an example for description. A principle is similar to other search terms provided by the user. Thus, second search terms of b1 are b2, b3 and b4 may be obtained according to the above description of FIG. 3a. Based on step 201b, when the similarity value between b2 and b3, the similarity value between b2 and b4 as well as the similarity value between b2 and b1 are all greater than or equal to a second preset threshold, three potential clustering relationships may be exploited additionally according to the embodiment of the present invention, which are a clustering relationship between b2 and b3, a clustering relationship between b2 and b4, as well as a clustering relationship between b3 and b4. Since the clustering relationship between b3 and b4 has already been determined in above step 202a, as an extension of the embodiment of the present invention, an operation for determining the clustering relationship between b3 and b4 may be omitted, and only the clustering relationship between b2 and b3 and the clustering relationship between b2 and b4 is needed to be added. Afterwards, a similarity value between b2 and b3 and a similarity value between b2 and b4 are calculated, and it is determined whether the clustering relationship between b2 and b3 and the clustering relationship between b2 and b4 meet a clustering standard. Specifically, based on step 202b above, it is determined whether the similarity value between b2 and b3 is greater than or equal to the first preset threshold; if it is determined that the similarity value between b2 and b3 is greater than or equal to the first preset threshold, it is determined that the clustering relationship between b2 and b3 is that b2 and b3 are equivalent and may be clustered together. Otherwise, it is determined that the clustering relationship between b2 and b3 is that b2 and b3 cannot be clustered together. A similar method is performed for the similarity value between b2 and b4.

When it is determined that two search terms connected with a dashed line in FIG. 3c are equivalent and may be clustered together according to description above, the dashed line is changed to a solid line. Otherwise, the dashed line is unchanged, i.e., the two search terms connected with the dashed line are not equivalent and cannot be clustered together. The dashed line may be removed subsequently. Afterwards, all search terms which are eventually connected by solid lines are taken as a final clustering result according to the embodiment of the present invention.

In the embodiment of the present invention, clustering relationships among search terms are denoted by a solid line (also called an edge relationship) between two search terms, therefore, only edge relationships may be traversed in the embodiment of the present invention, so that the complexity in the embodiment of the present invention is reduced to O(n+e), wherein n denotes the number of the search terms, and e denotes the number of the edge relationships.

It should be noted that as an extension of the embodiment of the present invention, a potential clustering relationship among second search terms related to a first search term provided by a user and “descendant” nodes of the second search terms within N hops (such as N=3) in FIG. 3 may be further exploited in the embodiment of the present invention. The specific implementation may refer to the process shown in FIG. 2b, and is not described in detail herein.

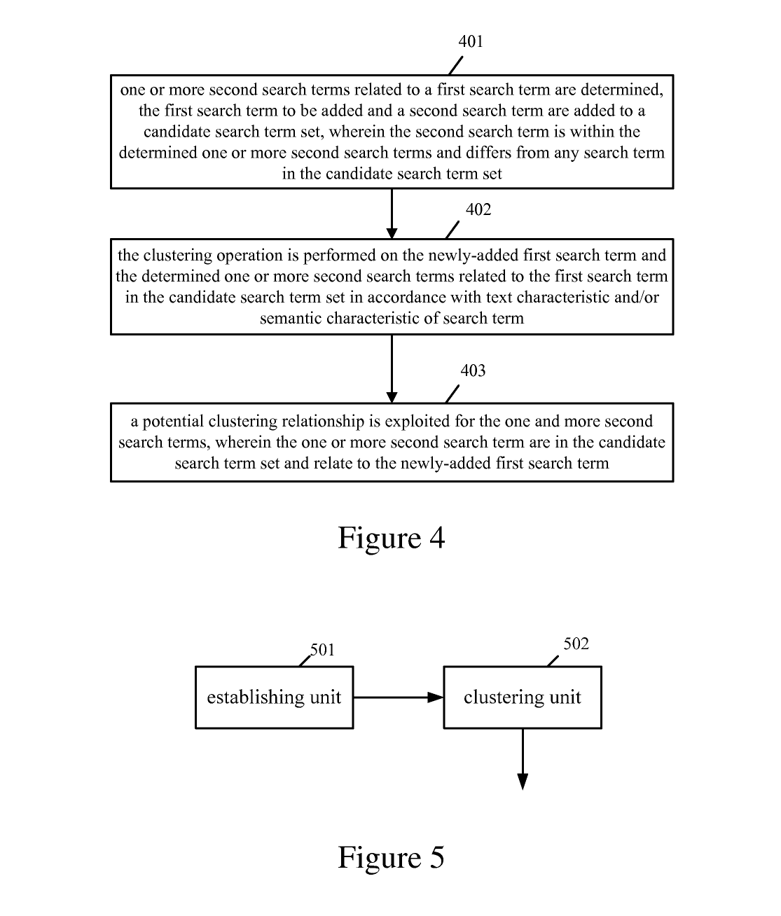

In addition, in a bid advertising system, a candidate search term set is not constant all the time, and search terms may be progressively added to the candidate search term set with the passage of time. For example, at a certain time point, a new first search term provided by a user is added to the candidate search term set. Compared with a previous search term, the newly-added first search term occurs newly. It is necessary to perform a similar clustering operation shown in FIG. 2a and FIG. 2b for the newly-added first search term. At the same time, a result obtained after performing the clustering operation is integrated together with a previous clustering result. A process is shown in FIG. 4.

As shown in FIG. 4, FIG. 4 is a flowchart illustrating a process for newly adding a first search term (referred to as an incremental update process) in accordance with an embodiment of the present invention. As shown in FIG. 4, the process may include steps as follows.

In step 401, one or more second search terms related to a first search term are determined, the first search term to be added and a second search term are added to a candidate search term set, wherein the second search term is within the determined one or more second search terms and differs from any search term in the candidate search term set.

For example, before step 401 is performed, search terms stored in the candidate search term set are b1 to b9, as shown in FIG. 3a. When step 401 is to be performed, two first search terms n1 and n2 are newly added. As shown in FIG. 3d, the second search terms related to n1 are b5 and b6, and the second search terms related to n2 are b1, b2, b3, b4, b8 and n3. Since b5 and b6 related to n1 and b1, b2, b3, b4 and b8 related to n2 have already existed in the candidate search term set, as a result, n1, n2, and n3 related to n2 are added to the candidate search term set in step 401.

In step 402, the clustering operation is performed on the newly-added first search term and the determined one or more second search terms related to the first search term in the candidate search term set in accordance with text characteristic and/or semantic characteristic of search term.

The clustering operation is similar to the process shown in FIG. 2a. the newly-added first search term n1 is taken as an example to describe step 402. Another newly-added search term has a similar principle.

Based on step 401, for n1, the second search terms related to n1 are determined as b5 and b6. Thus, when step 402 is to be performed, based on a process shown in FIG. 2a, a similarity value between n1 and b5 and a similarity value between n1 and b6 are calculated according to the text characteristic and/or the semantic characteristic of n1. And then it is determined whether the similarity value between n1 and b5 is greater than or equal to a first preset threshold, if it is determined that the similarity value between n1 and b5 is greater than or equal to the first preset threshold, it is determined that n1 and b5 are equivalent and may be clustered together. Otherwise, n1 and b5 may not be clustered together. The same operation is performed for the similarity value between n1 and b6.

In step 403, a potential clustering relationship is exploited for the one and more second search terms, wherein the one or more second search term are in the candidate search term set and relate to the newly-added first search term.

In step 403, the potential clustering relationship may be exploited according to the process shown in FIG. 2b, which is described simply as follows: selecting second search terms from all of the one or more second search terms related to the first search term or from all of the one or more second search terms clustered with the first search term, wherein a similarity value between the first search term and each of the second search terms is greater than or equal to a second preset threshold respectively; calculating a similarity value between any two selected second search terms, and clustering the two second search terms together when the calculated similarity value is greater than or equal to the first preset threshold.

The newly-added first search term n1 is still taken as an example. The second search terms related to n1 have already been determined as b5 and b6 in step 401. Therefore, when step 403 is to be performed, if a similarity value between b5 and n1 and a similarity value between b6 and n1 are all greater than the second preset threshold, a similarity value between b5 and b6 may be calculated. If the calculated similarity value is greater than or equal to the first preset threshold, the two search terms b5 and b6 are clustered together. Otherwise, b5 and b6 are not clustered together.

So far, a clustering relationship between the newly-added first search term (referred to as an incremental search term) and an existing search term (referred to as an old search term) (referred to hereinafter as an incremental clustering result) may be implemented through above-mentioned steps 401 to 403. The incremental clustering result and the previous existing total clustering result are collectively referred to as a final clustering result in the present invention.

It should be noted that in an embodiment of the present invention, a second search term related to a first search term is not fixed and may be changed according to search term addition or deletion by a user. Based on this, the method provided by the embodiment of the present invention should be able to reflect the change. This change is implemented by periodically updating a candidate search term set (referred to as a total update). The specific implementation is: when a configured total update time arrives, determining the second search term related to the first search term in a candidate search term set, adding both the first search term and the determined second search term related to the first search term to a new candidate search term set, afterwards performing the clustering operation on the first search term and the determined second search term related to the first search term according to the processes as shown in FIG. 2a and FIG. 2, obtaining a total clustering result. The implementation may be described according to Table 1.

It is assumed that a first search term provided by a user in the first day is B1, a QBM extension result corresponding to the first search term is Q1=Q(B1), the extension result mainly consists of a a set of second search term related to the first search term. A clustering result is C1=C(Q(B1)), which is obtained by performing clustering for the first search term and the second search term based on the processes shown in FIGS. 2a and 2b. As such, when it is needed to add a search term with the passage of time, as shown in Table 1:

| | incremental update | total update | remarks |
|---|---|---|---|
| The | a total search term up to the | | Only an incremental |
| second | present day: B2 | | update is performed, |
| day | an added search term: | | and a total update is |
| | B21 = B2 − B1 | | not performed. |
| | a QBM extension result | | |
| | corresponding to the added | | |
| | search term: Q(B21) | | |
| | an incremental clustering | | |
| | result: C(Q(B21)) | | |
| | a final clustering result: | | |
| | C2 = C(Q(B21))∪C1 | | |
| The | a total search term up to the | | Only an incremental |
| third day | present day: B₃ | | update is performed, |
| | an added search term: | | and a total update is |
| | B₃₂ = B₃ − B₂ | | not performed. |
| | a QBM extension result | | |
| | corresponding to the added | | |
| | search term: Q(B₃₂) | | |
| | an incremental clustering | | |
| | result: C(Q(B₃₂)) | | |
| | a final clustering result: | | |
| | C₃ = C(Q(B₃₂))∪C₂ | | |
| | . . . | | Only an incremental |
| | | | update is performed, |
| | | | and a total update is |
| | | | not performed. |
| The | a total search term up to the | Base on the total | A total update base |
| i-th day | present day: Bᵢ | search term data up | on the total search |
| | an added search term: | to the i-th day, a | term of the i-th day is |
| | Bᵢ₃ = Bᵢ − Bᵢ₋₁ | total update is | performed, this |
| | a QBM extension result | being | process may last for a |
| | corresponding to the added | prepared . . . | few days. |
| | search term: Q(B_{i (i-1)}) | | |
| | an incremental clustering | | |
| | result: C(Q(B_{i (i-1)})) | | |
| | a final clustering result: | | |
| | Cᵢ = C(Q(B_{i (i-1)}))∪Cᵢ₋₁ | | |
| | . . . | a total update is | |
| | | being | |
| | | prepared . . . | |
| The | . . . | a total update is | |
| j-th day | | being | |
| | | prepared . . . | |
| The | a total search term up to the | a newest total | Up to the k-th day, |
| k-th day | present day: Bₖ | QBM extension | the total clustering |
| | an added search term: | result: | result base on the total |
| | Bₖⱼ = Bₖ − Bⱼ | total_Qₖ = Q(Bᵢ) | search term data of the |
| | an incremental QBM | a corresponding | i-th day has already |
| | extension result corresponding to | total clustering | been calculated. |
| | the added search term: Q(Bₖⱼ) | result: | |
| | an incremental clustering | total_Cₖ = C(Q(Bᵢ)) | |
| | result: C(Q(Bₖⱼ)) | | |
| | a final clustering result: | | |
| | Cₖ = C(Q(Bₖⱼ))∪Cⱼ | | |
| The | total search term up to the | | Up to the L-th day, |
| L-th day | present day: B_{L} | | the clustering result of |
| | added search term: B_{Li} = B_{L} − Bᵢ | | the total search term |
| | a QBM extension result | | which has already |
| | corresponding to the added | | been calculated in the |
| | search term: Q(B_{Li}) | | k-th day is used for |
| | an incremental clustering | | synchronization; an |
| | result: C(Q(B_{Li})) | | incremental extension |
| | a final clustering result: | | is performed in an |
| | C_{L} = C(Q(B_{Li}))∪total_Cₖ | | incremental update |
| | | | process based on the |
| | | | newest total. Thus, the |
| | | | incremental search |
| | | | term is relative to the |
| | | | i-th day. |
| The | a total search term up to the | | Only an incremental |
| m-th day | present day: Bₘ | | update is performed, |
| | an incremental search term: | | and a total update is |
| | B_{mL} = Bₘ − B_{L} | | not performed. |
| | an incremental QBM | | a process cycle from |
| | extension result: Q(B_{mL}) | | beginning is repeated. |
| | an incremental clustering | | |
| | result: C(Q(B_{mL})) | | |
| | a final clustering result: | | |
| | Cₘ = C(Q(B_{mL}))∪C_{L} | | |

As can be seen from Table 1, the total update starts in the i-th day and ends in the k-th day; in the (k+1)-th (i.e., L-th) day, a synchronization for total data and incremental data are performed, i.e., the process shown in FIG. 4 is performed on all of the first search terms in the candidate search term up to the (k+1)-th (i.e., L-th) day.

An apparatus provided by an embodiment of the present invention is hereinafter described.

As shown in FIG. 5, FIG. 5 is a schematic diagram illustrating a basic structure of an apparatus in accordance with an embodiment of the present invention. As shown in FIG. 5, the apparatus may include:

establishing unit 501, to establish a candidate search term set, wherein the candidate search term set includes a first search term provided by a user, and a second search term related to the first search term.

clustering unit 502, to perform a clustering operation on the first search term and the second search term related to the first search term in the candidate search term set according to text characteristic and/or semantic characteristic of search term.

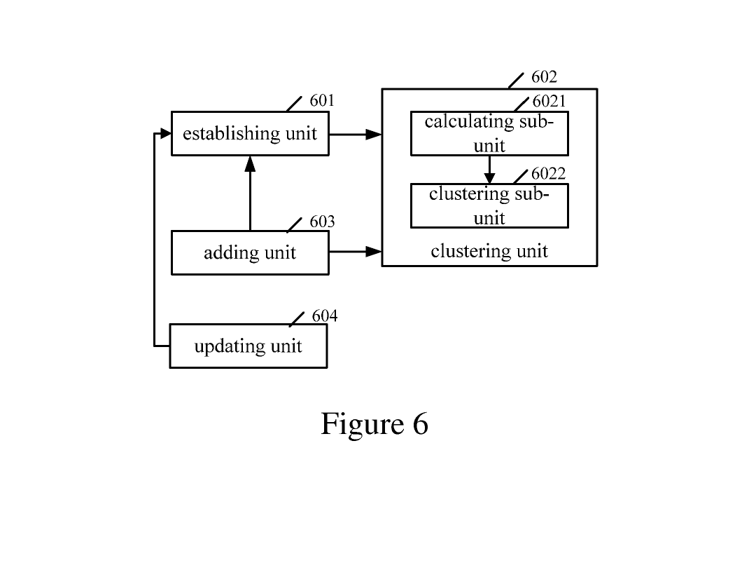

In specific implementation, the apparatus shown in FIG. 5 may refer to FIG. 6.

As shown in FIG. 6, FIG. 6 is a schematic diagram illustrating a detailed structure of an apparatus in accordance with an embodiment of the present invention. As shown in FIG. 6, the apparatus may include establishing unit 601 and clustering unit 602. Functions of establishing unit 601 and clustering unit 602 are respectively similar to establishing unit 501 and clustering unit 502 shown in FIG. 5, which are not described repeatedly herein.

Preferably, as shown in FIG. 6, the apparatus may further include:

adding unit 603, to determine one or more second search terms related to the first search term, adding the first search term to be added and a second search term to the candidate search term set when a user adds the first search term, wherein the second search term is within the determined one or more second search terms and differs from any search term in the candidate search term set.

Based on this, clustering unit 602 is further to perform the clustering operation on the newly-added first search term and the one or more second search terms related to the first search term in the candidate search term set according to the text characteristic and/or the semantic characteristic of search term.

Preferably, as shown in FIG. 6, the apparatus may further include:

updating unit 604, to determine the second search term related to the first search term in the candidate search term set, add both the first search term and the determined second search term related to the first search term to a new candidate search term set when a configured total update time arrives.

Based on this, clustering unit 602 is further to perform the clustering operation for the first search term and the second search term related to the first search term in the new candidate search term set in accordance with the text characteristic and/or the semantic characteristic of search term.

Specifically, clustering unit 602 performs the clustering operation through the following sub-units:

calculating sub-unit 6021, to calculate a similarity value between a first search term and a second search term related to the first search term in accordance with text characteristic and/or semantic characteristic of the first search term.

clustering sub-unit 6022, to cluster the first search term together with the second search term, when the similarity value between the first search term and the second search term is greater than or equal to a first preset threshold.

Preferably, clustering sub-unit 6022 is further to select second search terms from all of second search terms related to the first search term or from all of seconds search terms clustered with the first search term, wherein a similarity value between the first search term and each second search terms is greater than or equal to a second preset threshold respectively, calculate a similarity value between any two selected second search terms, and cluster the two second search terms together when the calculated similarity value is greater than or equal to the first preset threshold. The first preset threshold is unrelated to the second preset threshold.

The above is the description of the apparatus provided by the embodiment of the present invention.

As can be seen from the above technical solution, in the method and apparatus provided by embodiments of the present invention, when search terms are clustered, a search term provided by a user and another search term related to the search term provided by the user are taken into account rather than only performing clustering of a literal relationship for the search term provided by the user just in prior art. The clustering is performed for the search term provided by the user and the another search term related to the search term provided by the user according to text characteristic and/or semantic characteristic of search term, thereby increasing the accuracy of the search term clustering obviously.

Furthermore, clustering relationships among second search terms related to a first search term provided by the user are exploited in embodiments of the present invention, which can deeply exploit clustering relationships among search terms and make the search term clustering more accurate compared to the prior art.

The above are just preferable embodiments of the present invention, and are not used for limiting the protection scope of the present invention. Any modifications, equivalents, improvements, etc., made under the spirit and principle of the present invention, are all included in the protection scope of the present invention.

1. A method for clustering search terms, comprising:
establishing a candidate search term set, wherein the candidate search term set comprises a first search term provided by a user, and a second search term related to the first search term;
calculating a similarity value between the first search term and the second search term related to the first search term according to text characteristic and/or semantic characteristic of the first search term, clustering the first search term and the second search term together when the similarity value between the first search term and the second search term is greater than or equal to a first preset threshold;
selecting second search terms from all of second search terms related to the first search term or from all of seconds search terms clustered with the first search term, wherein a similarity value between the first search term and each of the second search terms is greater than or equal to a second preset threshold respectively; and
calculating a similarity value between any two selected second search terms, and clustering the two second search terms together when the calculated similarity value is greater than or equal to the first preset threshold.
performing a clustering operation on the first search term and the second search term related to the first search term in the candidate search term set according to text characteristic and/or semantic characteristic of search term.

2. The method according to claim 1, when the user adds the first search term, further comprising:
determining one or more second search terms related to the first search term, adding the first search term to be added and a second search term to the candidate search term set, wherein the second search term is within the determined one or more second search terms and differs from any search term in the candidate search term set;
performing the clustering operation on the newly-added first search term and the determined one or more second search terms related to the first search term in the candidate search term set in accordance with the text characteristic and/or the semantic characteristic of search term.

3. The method according to claim 1, further comprising:
determining the second search term related to the first search term in the candidate search term set, adding both the first search term and the determined second search term related to the first search term to a new candidate search term set, performing the clustering operation for the first search term and the determined second search term related to the first search term according to the text characteristic and/or the semantic characteristic of search term when a configured total update time arrives.

4.-5. (canceled)

6. The method according to claim 1, wherein the second search term related to the first search term comprises:
a search term matching the first search term, and/or a search term in a search result when the first search term is taken as a keyword to obtain a search result through search.

7. An apparatus for clustering search terms, comprising:
an establishing unit, to establish a candidate search term set, wherein the candidate search term set comprises a first search term provided by a user, and a second search term related to the first search term; and
a clustering unit, to perform a clustering operation on the first search term and the second search term related to the first search term in the candidate search term set according to text characteristic and/or semantic characteristic of search term.
wherein the clustering unit performs the clustering operation through sub-units as follows:
a calculating sub-unit, to calculate a similarity value between the first search term and the second search term related to the first search term in accordance with the text characteristic and/or the semantic characteristic of the first search term;
a clustering sub-unit, to cluster the first search term together with the second search term, when the similarity value between the first search term and the second search term is greater than or equal to a first preset threshold; and
the clustering sub-unit is further to select third search terms from all of second search terms related to the first search term or from all of seconds search terms clustered with the first search term, wherein a similarity value between the first search term and each of the third search terms is greater than or equal to a second preset threshold respectively, calculate a similarity value between any two selected third search terms, and cluster the two third search terms together when the calculated similarity value is greater than or equal to the first preset threshold.

8. The apparatus according to claim 7, further comprising:
an adding unit, to determine one or more second search terms related to the first search term, add the first search term to be added and a second search term to the candidate search term set when a user adds the first search term, wherein the second search term is within the determined one or more second search terms and differs from any search term in the candidate search term set;
the clustering unit is further to perform the clustering operation on the newly-added first search term and the one or more second search terms related to the first search term in the candidate search term set according to the text characteristic and/or the semantic characteristic of search term.

9. The apparatus according to claim 7, further comprising:
an updating unit, to determine the second search term related to the first search term in the candidate search term set, add both the first search term and the determined second search term related to the first search term to a new candidate search term set when a configured total update time arrives;
the clustering unit is further to perform the clustering operation for the first search term and the second search term related to the first search term in the new candidate search term set in accordance with the text characteristic and/or the semantic characteristic of search term.

10.-11. (canceled)
